(19) United States
(12) Patent Application Publication
(10) Pub. No.: US 2026/0335974 A1
(43) Pub. Date: Oct. 29, 2026

(54) STAINLESS STEEL POWDER, STAINLESS STEEL COMPONENT, AND METHOD FOR MANUFACTURING STAINLESS STEEL COMPONENT

(71) Applicant: JFE STEEL CORPORATION, Tokyo (JP)

(72) Inventors: Kenichiro EGUCHI, Tokyo (JP); Takuya TAKASHITA, Tokyo (JP); Shinsuke IDE, Tokyo (JP)

(73) Assignee: JFE STEEL CORPORATION, Tokyo (JP)

(21) Appl. No.: 19/113,529

(22) PCT Filed: Sep. 15, 2023
(86) PCT No.: PCT/JP2023/033803

§ 371 Date: Mar. 20, 2025

(30) Foreign Application Priority Data
Sep. 29, 2022 (JP) 2022-155700

(51) Int. Cl. B22F 1/05; B22F 10/28; B33Y 10/00; B33Y 70/00; B33Y 80/00; C22C 38/00; C22C 38/02; C22C 38/04; C22C 38/06; C22C 38/44; C22C 38/46

(52) U.S. Cl. CPC B22F 1/05; B22F 10/28; C22C 38/001; C22C 38/002; C22C 38/02; C22C 38/04; C22C 38/06; C22C 38/44; C22C 38/46; B22F 2301/35; B33Y 10/00; B33Y 70/00; B33Y 80/00

(57) ABSTRACT

A stainless steel powder allows manufacture of a stainless steel component having high strength, excellent low-temperature toughness, and excellent corrosion resistance in a high-temperature severe corrosive environment containing carbon dioxide gas and chloride ions, an environment containing hydrogen sulfide. The stainless steel powder has a particular composition, has a particle size D₅₀, of 10 to 200 μm, and has an apparent density of 3.5 to 5.0 Mg/m³.

### CROSS-REFERENCE TO RELATED APPLICATIONS

This application is a national stage application of PCT Application No. PCT/JP2023/033803, which was filed Sep. 15, 2023, and which claims foreign priority to JP2022-155700, filed Sep. 29, 2022. These prior applications are hereby incorporated by reference in their entireties.

### TECHNICAL FIELD

This disclosure relates to a stainless steel powder suitable for manufacturing high-strength stainless steel couplings, parts or accessories for use in an oil or gas well for crude oil or natural gas (hereinafter referred to simply as an oil well). The present disclosure also relates to a stainless steel component formed using the stainless steel powder and to a method for manufacturing the stainless steel component.

### BACKGROUND

In recent times, in view of the depletion of energy resources which is expected in the near future, development is actively performed in deep oil fields and in oil and gas fields in a severely corrosive environment, a so-called sour environment, containing carbon dioxide gas, hydrogen sulfide, etc. Such oil and gas fields, whose development has not been considered in the past, generally have a very large depth, a high-temperature atmosphere, and a severely corrosive environment containing CO₂, Cl⁻, and H₂S. Oil well steel pipes for use in such an environment are required to have high strength and high corrosion resistance. Further, since development in cold regions and deep seas is increasingly active, low-temperature toughness is also required.

Oil wells in a corrosive environment at a temperature as high as 150 °C are being developed recently, and 13Cr or 15Cr stainless steel is used in such an environment. Patent Literatures 1 to 8, for example, disclose a 13Cr stainless steel pipe. Patent Literature 9 discloses a forming method involving a rapid melting and rapid solidification process.

### CITATION LIST

### Patent Literature

PTL 1: International Publication No. WO 2008/023702
PTL 2: Japanese Unexamined Patent Application Publication No. H9-170019
PTL 3: Japanese Unexamined Patent Application Publication No. H7-166303
PTL 4: Japanese Unexamined Patent Application Publication No. 2010-242163
PTL 5: International Publication No. WO 2017/038178
PTL 6: International Publication No. WO 2018/079111
PTL 7: International Publication No. WO 2019/065115
PTL 8: International Publication No. WO 2019/065116
PTL 9: Japanese Unexamined Patent Application Publication No. 2019-119913

### SUMMARY

### Technical Problem

The techniques as disclosed in Patent Literatures 1 to 9 have problems such as poor corrosion resistance especially in a high-temperature severely corrosive environment containing carbon dioxide gas (CO₂) and chlorine ions (Cl⁻), or in an environment containing hydrogen sulfide (H₂S). Therefore, these conventional stainless steel pipes sometimes cannot withstand the increasingly severe environments of current oil and gas fields.

It is therefore an object of the present disclosure to solve the problems of the conventional art and provide a stainless steel powder, suitable for forming, which allows manufacture of a stainless steel component having high strength, excellent low-temperature toughness, and excellent corrosion resistance especially in a high-temperature severe corrosive environment containing carbon dioxide gas (CO₂) and chlorine ions (Cl⁻), an environment containing hydrogen sulfide (H₂S), etc. It is also an object of the present disclosure to provide a stainless steel component having high strength, excellent low-temperature toughness, and excellent corrosion resistance in such an environment, and to provide a method for manufacturing the stainless steel component.

In the present disclosure, “high strength” refers to a yield strength of 655 MPa or more.

“Excellent low-temperature toughness” refers to the case in which, when a Charpy impact test is performed on a V-notch test specimen (10 mm thick), which has been taken according to JIS Z 2242 such that the longitudinal direction of the specimen is perpendicular to the forming direction and the notch is parallel to the forming direction, the absorbed energy vE₋₁₀ at a test temperature of −10 °C in the Charpy impact test is 40 J or more.

“Excellent corrosion resistance” refers to the possession of “excellent corrosion resistance to carbon dioxide gas” and “excellent resistance to sulfide stress corrosion cracking”.

When the Cr content in the steel is 14.0% or less, the “excellent corrosion resistance to carbon dioxide gas” refers to the case in which in a corrosion test as performed by immersing a test specimen in a test solution, which is a 20 mass % aqueous NaCl solution held in an autoclave (solution temperature: 150 °C, 10-atm CO₂ gas atmosphere), for 336 hours, the corrosion rate is 0.125 mm/y or less, and in which when the test specimen after the corrosion test is observed for the presence or absence of pitting corrosion on the surface of the test specimen using a magnifying lens at 10-fold magnification, no pitting corrosion having a diameter of 0.2 mm or more is found. When the Cr content in the steel is more than 14.0%, the “excellent corrosion resistance to carbon dioxide gas” refers to the case in which in a corrosion test as performed by immersing a test specimen in a test solution, which is a 20 mass % aqueous NaCl solution held in an autoclave (solution temperature: 180 °C, 10-atm CO₂ gas atmosphere), for 336 hours, the corrosion rate is 0.125 mm/y or less, and in which when the test specimen after the corrosion test is observed for the presence or absence of pitting corrosion on the surface of the test specimen using a magnifying lens at 10-fold magnification, no pitting corrosion having a diameter of 0.2 mm or more is found.

The “excellent resistance to sulfide stress corrosion cracking” refers to the case in which in a corrosion test as performed by immersing a test specimen in a test solution, which is a 5 mass % aqueous NaCl solution (solution temperature: 25 °C, H₂S: 0.1 atm, CO₂: 0.9 atm) whose pH has been adjusted to 3.5 by adding acetic acid and Na acetate thereto, for 720 hours, and applying a load stress, which is 90% of the yield stress, to the test specimen, no crack is observed in the test specimen after the test.

### Solution to Problem

In order to solve the above problems, the present inventors focused on an additive manufacturing process, which is a method of manufacturing a three-dimensional object using a so-called 3D printer (3D printing method). In an additive manufacturing process, a stainless steel powder as a raw material is rapidly heated and cooled during the process. This will make the microstructure significantly finer, resulting in a decrease of non-metal inclusions (hereinafter referred to as inclusions), which are known to cause a deterioration of the corrosion resistance, or a reduction in the size of such inclusions. The present inventors made studies on various factors that affect the strength, corrosion resistance, and low-temperature toughness of the chemical composition of a stainless steel component formed by an additive manufacturing process.

In particular, a master ingot produced by a melting-casting process was remelted, and the melt was subjected to gas atomization to produce a stainless steel powder. A formed object was manufactured by so-called 3D printing using the stainless steel powder. Using such formed objects, studies were made on the above various factors. These studies revealed that in order for a formed object to satisfy the desired strength, corrosion resistance, and low-temperature toughness, the particle size (median diameter in the mass cumulative distribution (mass basis)) D₅₀, and the apparent density of the stainless steel powder of the components should be maintained within desired ranges.

The present inventors also found that by subjecting a formed object to an appropriate heat treatment, it is possible to obtain a component having a steel microstructure sufficient to satisfy the desired strength, corrosion resistance, and low-temperature toughness, and that a desired high strength, an excellent low-temperature toughness, and an excellent corrosion resistance (corrosion resistance to carbon dioxide gas and resistance to sulfide stress corrosion cracking) can therefore be achieved for a component of any shape.

The present embodiments are based on the above findings and on an additional study. The present disclosure can be summarized as follows.
[1] A stainless steel powder having a chemical composition including, in % by mass:
C: 0.001 to 0.06%;
Si: 0.01 to 1.0%;
Mn: 0.01 to 2.0%;
P: 0.05% or less;
S: less than 0.005%;
Cr: more than 11.0% and not more than 15.0%;
Ni: 2.5 to 8.0%;
V: 0.005 to 0.5%;
Al: 0.1% or less;
N: 0.100% or less;
O: 0.3% or less; and
Mo: 3.5% or less,
with the balance being Fe and incidental impurities,
wherein the stainless steel powder has a particle size D₅₀, which is a median diameter at a 50% position in a mass cumulative distribution, of 10 to 200 μm, and an apparent density of 3.5 to 5.0 Mg/m³.
[2] The stainless steel powder according to [1], wherein the chemical composition further includes, in % by mass, at least one selected from the following:
Cu: 3.5% or less;
W: 3.0% or less;
Nb: 0.5% or less;
Ti: 0 to 0.30%;
B: 0 to 0.0050%;
Zr: 0 to 0.2%;
Co: 0 to 1.0%;
Ta: 0 to 0.1%;
Ca: 0 to 0.050%;
rare-earth metals (REM): 0 to 0.1%;
Mg: 0 to 0.01%;
Sn: 0 to 0.5%; and
Sb: 0 to 0.5%.
[3] A stainless steel component having a chemical composition including, in % by mass:
C: 0.001 to 0.06%;
Si: 0.01 to 1.0%;
Mn: 0.01 to 2.0%;
P: 0.05% or less;
S: less than 0.005%;
Cr: more than 11.0% and not more than 15.0%;
Ni: 2.5 to 8.0%;
V: 0.005 to 0.5%;
Al: 0.1% or less;
N: 0.100% or less;
O: 0.3% or less; and
Mo: 3.5% or less,
with the balance being Fe and incidental impurities,
wherein the stainless steel component has a steel microstructure including, by volume fraction, 45% or more of a tempered martensite phase, 0 to 40% of a ferrite phase, and 25% or less of a retained austenite phase, has a yield strength of 655 MPa or more, and has an absorbed energy vE₋₁₀, determined at a test temperature of −10 °C in a Charpy impact test, of 40 J or more.
[4] The stainless steel component according to [3], wherein the chemical composition further includes, in % by mass, at least one selected from the following:
Cu: 3.5% or less;
W: 3.0% or less;
Nb: 0.5% or less;
Ti: 0 to 0.30%;
B: 0 to 0.0050%;
Zr: 0 to 0.2%;
Co: 0 to 1.0%;
Ta: 0 to 0.1%;
Ca: 0 to 0.050%;
REM: 0 to 0.1%;
Mg: 0 to 0.01%;
Sn: 0 to 0.5%; and
Sb: 0 to 0.5%.
[5] The stainless steel component according to [3] or [4], wherein the number of inclusions having a major diameter of 2 μm or more is 10/mm² or less.
[6] The stainless steel component according to any one of [3] to [5], wherein in the tempered martensite phase, among crystal grains having an orientation difference of 5° or more from adjacent grains, the number of crystal grains having a grain size of 5 μm or more is 10% or less of the total number of crystal grains.
[7] A method for manufacturing a stainless steel component, including:
a forming step of forming an object using the stainless steel powder according to [1] or [2]; and
a heat treatment step including at least one quenching treatment which involves heating the object to a temperature in the range of 850 to 1150 °C, and then cooling the object to a temperature in the range of not more than 50 °C at an average cooling rate equal to or greater than that of air cooling, and at least one tempering treatment which involves heating the object to a temperature in the range of 500 to 650 °C.
[8] The method for manufacturing a stainless steel component according to [7], wherein the forming step is a step of forming the object using an additive manufacturing process.

### Advantageous Effects of Disclosure

According to the present disclosure, it is possible to provide a stainless steel powder, a stainless steel component using the powder, and a method for manufacturing the stainless steel component. The stainless steel powder can advantageously be used in particular for manufacturing stainless steel components by additive manufacturing.

A stainless steel component, manufactured using the stainless steel powder of the present disclosure, has high strength and excellent low-temperature toughness, and also has excellent corrosion resistance even in a severely corrosive environment at a temperature as high as 150 °C or more and containing CO₂ and Cl⁻, or an environment containing H₂S.

### DESCRIPTION OF EMBODIMENTS

The present disclosure will now be described in detail.

The stainless steel powder of the present disclosure has a chemical composition as described below, and has a particle size D₅₀ and an apparent density which are each controlled within an appropriate range. The stainless steel component of the present disclosure is formed from the stainless steel powder, and has the same chemical composition as the below-described composition of the stainless steel powder, and a steel microstructure controlled within an appropriate range.

The chemical composition of the stainless steel powder and stainless steel component of the present disclosure, and reasons for limitations in the composition will be described first. “% by mass” will be hereinafter expressed simply as “%” unless otherwise specified.

### C: 0.001 to 0.06%

C is an element which increases the strength of martensitic stainless steel. In the present disclosure, in order to ensure the desired high strength, C needs to be contained in an amount of 0.001% or more. Therefore, the C content is 0.001% or more. The C content is preferably 0.005% or more, more preferably 0.015% or more. On the other hand, when C is contained in an amount exceeding 0.06%, the sulfide stress corrosion cracking (SSCC) resistance will be low. Therefore, the C content is 0.06% or less. The C content is preferably 0.04% or less, more preferably 0.03% or less.

### Si: 0.01 to 1.0%

Si is an element which acts as a deoxidizer. To achieve this effect, Si needs to be contained in an amount of 0.01% or more. Therefore, the Si content is 0.01% or more. The Si content is preferably 0.1% or more, more preferably 0.15% or more. On the other hand, when Si is contained in an amount exceeding 1.0%, the low-temperature toughness will be low. Therefore, the Si content is 1.0% or less. The Si content is preferably 0.8% or less, more preferably 0.6% or less, and even more preferably 0.4% or less.

### Mn: 0.01 to 2.0%

Mn is an element which increases the strength of martensitic stainless steel. To ensure the desired strength, Mn needs to be contained in an amount of 0.01% or more. Therefore, the Mn content is 0.01% or more. The Mn content is preferably 0.1% or more, more preferably 0.15% or more, and even more preferably 0.25% or more. On the other hand, when Mn is contained in an amount exceeding 2.0%, the low-temperature toughness will be low. Therefore, the Mn content is 2.0% or less. The Mn content is preferably 1.0% or less, more preferably 0.8% or less, and even more preferably 0.6% or less.

### P: 0.05% or Less

P is an element which reduces corrosion resistance such as corrosion resistance to carbon dioxide gas and resistance to sulfide stress corrosion cracking. In the present disclosure, the P content is preferably as low as possible, while a content of 0.05% or less is acceptable. Therefore, the P content is 0.05% or less. The P content is preferably 0.03% or less, more preferably 0.02% or less. The lower limit of the P content is not particularly limited; however, the P content is preferably 0.005% or more.

S: Less than 0.005%

S is an element which reduces the corrosion resistance. The S content is preferably as low as possible, while a content of less than 0.005% is acceptable. Therefore, the S content is less than 0.005%. The S content is preferably 0.003% or less, more preferably 0.002% or less. The lower limit of the S content is not particularly limited; however, the S content is preferably 0.0004% or more.

Cr: More than 11.0% and not More than 15.0%

Cr is an element which forms a protective film on the surface of a steel pipe, thereby contributing to improving the corrosion resistance. When the Cr content is 11.0% or less, the desired corrosion resistance cannot be ensured. Therefore, the Cr content is more than 11.0%. The Cr content is preferably 11.5% or more, more preferably 12.0% or more, and even more preferably 12.5% or more. On the other hand, when the Cr content exceeds 15.0%, it is excessive for the purpose of achieving the desired corrosion resistance and increases the cost. Further, such a high Cr content is disadvantageous in terms of low-temperature toughness. Therefore, the Cr content is 15.0% or less. The Cr content is preferably 14.5% or less, more preferably 14.0% or less, and even more preferably 13.5% or less.

### Ni: 2.5 to 8.0%

Ni is an element which strengthens a protective film on the surface of a steel pipe, thereby contributing to improving the corrosion resistance. This effect is pronounced when Ni is contained in an amount of 2.5% or more. Therefore, the Ni content is 2.5% or more. The Ni content is preferably 3.0% or more, more preferably 3.5% or more, and even more preferably 5.0% or more. On the other hand, when the Ni content exceeds 8.0%, the stability of a martensite phase will be low, leading to low strength. Therefore, the Ni content is 8.0% or less. The Ni content is preferably 7.5% or less, more preferably 7.0% or less, and even more preferably 6.5% or less.

### V: 0.005 to 0.5%

V is an element which contributes to increasing the strength through solid solution. Further, V combines with C and N and precipitates as a V carbonitride (V precipitate), thereby contributing to increasing the yield strength. To achieve these effects, V needs to be contained in an amount of 0.005% or more. Therefore, the V content is 0.005% or more. The V content is preferably 0.01% or more, more preferably 0.02% or more, and even more preferably 0.03% or more. On the other hand, the inclusion of V in an amount exceeding 0.5% leads to a reduction in the low-temperature toughness and in the resistance to sulfide stress corrosion cracking. Therefore, the V content is 0.5% or less. The V content is preferably 0.3% or less, more preferably 0.2% or less, and even more preferably 0.1% or less.

### Al: 0.1% or Less

Al is an element which acts as a deoxidizer. On the other hand, when Al is contained in an amount exceeding 0.1%, the amount of an oxide will increase, resulting in a reduction in the cleanliness as well as a reduction in the low-temperature toughness and the corrosion resistance. Therefore, the Al content is 0.1% or less. The Al content is preferably 0.07% or less, more preferably 0.05% or less. The lower limit of the Al content is not particularly limited; the Al content is desirably 0% or more. The Al content is preferably 0.01% or more, more preferably 0.02% or more.

### N: 0.100% or Less

N is an element which improves the pitting corrosion resistance. On the other hand, when N is contained in an amount exceeding 0.100%, the low-temperature toughness and the corrosion resistance will be reduced through the formation of a nitride. Therefore, the N content is 0.100% or less. The N content is preferably 0.080% or less, more preferably 0.070% or less, and even more preferably 0.060% or less. The lower limit of the N content is not particularly limited; the N content is desirably 0% or more. The N content is preferably 0.005% or more.

### O: 0.3% or Less

O (oxygen) exists as an oxide in steel, and therefore has an adverse effect on various properties. Therefore, in the present disclosure, the O content is desirably as low as possible. While the lower limit of the O content is not particularly limited, the O content is preferably 0.01% or more. In particular, when the O content exceeds 0.3%, the corrosion resistance and the low-temperature toughness will be low. Therefore, the O content is 0.3% or less. The O content is preferably 0.2% or less, more preferably 0.1% or less.

### Mo: 3.5% or Less

Mo is an element which stabilizes a protective film on the surface of a steel pipe and increases resistance to pitting corrosion caused by Cl⁻ or low pH, thereby improving the resistance to sulfide stress corrosion cracking. The lower limit of the Mo content is not particularly limited; the Mo content is preferably 0% or more. The Mo content is more preferably 0.4% or more, even more preferably 1.0% or more, and most preferably 1.8% or more. On the other hand, the inclusion of Mo in an amount exceeding 3.5% increases the ferrite fraction and decreases the tempered martensite fraction, resulting in a reduction in the resistance to sulfide stress corrosion cracking. In addition, Mo is an expensive element; a higher Mo content leads to an increased material cost. Therefore, the Mo content is 3.5% or less. The Mo content is preferably 3.2% or less, more preferably less than 3.0%, even more preferably 2.7% or less, and most preferably 2.5% or less.

The balance other than the above-described components is Fe and incidental impurities.

The chemical composition according to the present disclosure basically includes the above-described components. The basic chemical composition can achieve properties intended for the present disclosure. In the present disclosure, the chemical composition may further include the following components as optional elements in order to further improve the strength, the corrosion resistance, etc.

At least one selected from Cu: 3.5% or less, W: 3.0% or less, Nb: 0.5% or less, Ti: 0 to 0.30%, B: 0 to 0.0050%, Zr: 0 to 0.2%, Co: 0 to 1.0%, Ta: 0 to 0.1%, Ca: 0 to 0.050%, REM: 0 to 0.1%, Mg: 0 to 0.01%, Sn: 0 to 0.5%, and Sb: 0 to 0.5%.

### Cu: 3.5% or Less

Cu increases the retained austenite phase and forms precipitates, thereby contributing to improving the yield strength (YS). Thus, high strength can be achieved without reducing the low-temperature toughness. Cu also has the effect of strengthening a protective film on the surface of a steel pipe to prevent the entry of hydrogen into the steel, thereby enhancing the resistance to sulfide stress corrosion cracking. The lower limit of the Cu content is not particularly limited. When Cu is contained, the Cu content is preferably 0% or more, more preferably 0.3% or more, even more preferably 0.5% or more, and most preferably 1.0% or more. On the other hand, the inclusion of Cu in an amount exceeding 3.5% causes coarse Cu precipitation, resulting in a deterioration of the resistance to sulfide stress corrosion cracking. Therefore, when Cu is contained, the Cu content is 3.5% or less. The Cu content is preferably 3.0% or less, more preferably 2.0% or less, and even more preferably 1.5% or less.

### W: 3.0% or Less

W is an element which can contribute to increasing the strength of steel and can stabilize a protective film on the surface of a steel pipe, thereby improving the resistance to sulfide stress corrosion cracking. In particular, W significantly improves the resistance to sulfide stress corrosion cracking when it is contained in combination with Mo. The lower limit of the W content is not particularly limited. When W is contained, the W content is preferably more than 0%, more preferably 0.3% or more, even more preferably 0.5% or more, and most preferably 0.8% or more. On the other hand, the inclusion of W in an amount exceeding 3.0% promotes precipitation of an intermetallic compound, thereby reducing the corrosion resistance. Therefore, when W is contained, the W content is 3.0% or less. The W content is preferably 2.5% or less, more preferably 2.0% or less, and even more preferably 1.0% or less.

### Nb: 0.5% or Less

Nb combines with C and N and precipitates as a Nb carbonitride (Nb precipitate), thereby contributing to increasing the yield strength. The lower limit of the Nb content is not particularly limited. When Nb is contained, the Nb content is preferably 0% or more, more preferably 0.01% or more, and even more preferably 0.05% or more. On the other hand, the inclusion of Nb in an amount exceeding 0.5% leads to a reduction in the low-temperature toughness and in the resistance to sulfide stress corrosion cracking. Therefore, when Nb is contained, the Nb content is 0.5% or less. The Nb content is preferably 0.3% or less, more preferably 0.2% or less, and even more preferably 0.1% or less.

Ti, B, Zr, Co, and Ta are all elements that increase the strength, and one or more of these elements may be selected and included as desired. In addition to this effect, Ti, B, Zr, Co, and Ta also have the effect of improving the resistance to sulfide stress corrosion cracking. In particular, Ta is an element which achieves the same effect as Nb; part of Nb can be replaced with Ta. Ti, B, Zr, Co, and Ta are optional elements and need not be contained. The content of each element is desirably 0% or more. Thus, when Ti is contained, the Ti content is preferably 0% or more, more preferably 0.01% or more. When B is contained, the B content is preferably 0% or more, more preferably 0.0001% or more. When Zr is contained, the Zr content is preferably 0% or more, more preferably 0.01% or more. When Co is contained, the Co content is preferably 0% or more, more preferably 0.01% or more. When Ta is contained, the Ta content is preferably 0% or more, more preferably 0.01% or more. On the other hand, the low-temperature toughness will be low when the contents of the elements exceed the following values: Ti 0.30%, B 0.0050%, Zr 0.2%, Co 1.0% and Ta 0.1%. Therefore, when Ti is contained, the Ti content is 0.30% or less, preferably 0.10% or less. When B is contained, the B content is 0.0050% or less, preferably 0.0030% or less. When Zr is contained, the Zr content is 0.2% or less, preferably 0.05% or less. When Co is contained, the Co content is 1.0% or less, preferably 0.4% or less. When Ta is contained, the Ta content is 0.1% or less, preferably 0.03% or less.

Both Ca and REM (rare earth metals) are elements which contribute to improving the resistance to sulfide stress corrosion cracking through sulfide shape control. Ca and REM are optional elements and need not be contained; the content of each element is desirably 0% or more. When Ca is contained in order to achieve the above-described effect, the Ca content is preferably 0.0001% or more, more preferably 0.001% or more. When REM is contained, the REM content is preferably 0.001% or more, more preferably 0.003% or more. On the other hand, when the Ca content exceeds 0.050% or the REM content exceeds 0.1%, the effect will be saturated: an effect that matches the content will not be achieved. Therefore, when Ca is contained, the Ca content is 0.050% or less, preferably 0.005% or less. When REM is contained, the REM content is 0.1% or less, preferably 0.01% or less.

Mg, Sn, and Sb are all elements that improve the corrosion resistance. Mg, Sn, and Sb are optional elements and need not be contained; the content of each element is desirably 0% or more. When these elements are contained in order to achieve the above-described effect, Mg is preferably contained in an amount of 0.002% or more, Sn in an amount of 0.01% or more, and Sb in an amount of 0.01% or more. Thus, when Mg is contained, the Mg content is preferably 0% or more, more preferably 0.002% or more. When Sn is contained, the Sn content is preferably 0% or more, more preferably 0.01% or more. When Sb is contained, the Sb content is preferably 0% or more, more preferably 0.01% or more. On the other hand, when the Mg content exceeds 0.01%, the Sn content exceeds 0.5%, or the Sb content exceeds 0.5%, the effect will be saturated: an effect that matches the content will not be achieved. Therefore, when Mg is contained, the Mg content is 0.01% or less. When Sn is contained, the Sn content is 0.5% or less, preferably 0.2% or less. When Sb is contained, the Sb content is 0.5% or less, preferably 0.2% or less.

The particle size of the stainless steel powder of the present disclosure will now be described.

The stainless steel powder of the present disclosure has a particle size, defined by D₅₀, of 10 to 200 μm. When the particle size D₅₀ is too small, uneven filling of the powder will occur due to low fluidity of the powder, causing defects such as voids during additive manufacturing. This may result in a significant reduction in the low-temperature toughness and in the corrosion resistance (pitting corrosion resistance, SSCC resistance). Such a phenomenon may occur when the particle size D₅₀ is less than 10 μm. Therefore, the particle size D₅₀ is 10 μm or more. The particle size D₅₀ is preferably 15 μm or more, more preferably 20 μm or more, and even more preferably 30 μm or more. On the other hand, when the particle size D₅₀ is too large, the too-large particles will cause defects during additive manufacturing. This may result in a significant reduction in the low-temperature toughness and in the corrosion resistance (pitting corrosion resistance, SSCC resistance). Such a phenomenon may occur when the particle size D₅₀ exceeds 200 μm. Therefore, the particle size D₅₀ is 200 μm or less. The particle size D₅₀ is preferably 175 μm or less, more preferably 150 μm or less, even more preferably 125 μm or less, and most preferably 100 μm or less.

The particle size D₅₀ of the stainless steel powder refers to a median diameter, which is the value at the 50% position in the mass cumulative distribution of the powder. A laser diffraction particle size analyzer can be used to measure the median diameter. In the present disclosure, the particle size D₅₀ of the stainless steel powder is measured by the following method.

LA-950V2, manufactured by HORIBA, Ltd, is an example of the laser diffraction particle size analyzer. While any other device may of course be used, it is preferred to use one in which the lower limit of the measurable particle size range is 0.1 μm or less and the upper limit is 45 μm or more in order to perform accurate measurement. Thus, it is preferred to use one capable of measurement in the range of 0.1 to 45 μm. The particle size analyzer applies a laser beam to a solvent in which iron powder is dispersed, and measures the particle size distribution and the average particle size of the iron powder from the diffraction/scattering intensity of the laser beam. Ethanol, which disperses the iron powder well and is easy to handle, is preferably used as the solvent for dispersing the iron powder. The use of a solvent like water, which has a strong van der Waals force and poorly disperses the iron powder, is undesirable because the particles may agglomerate during measurement, resulting in a measured value which is larger than the true average particle size. The ethanol solution containing the iron powder is preferably subjected to an ultrasonic dispersion treatment before performing the measurement.

An appropriate period of time for the dispersion treatment varies depending on the powder to be measured. Therefore, the dispersion treatment is performed in seven stages at 10-minute intervals during 0 to 60 minutes, and after each dispersion treatment, measurement of the average particle size of the iron powder is performed. During each measurement, the solvent is stirred to prevent agglomeration of the particles. Among the particle sizes obtained in the seven measurements, each performed after each of the dispersion treatments carried out at 10-minute intervals, the lowest value is used as the particle size (particle size D₅₀) of the iron powder.

The above-described properties can be obtained by controlling both the particle size D₅₀ and the apparent density. When the apparent density is less than 3.5 Mg/m³, the fluidity will be low, resulting in the formation of defects during additive manufacturing. Therefore, the apparent density is 3.5 Mg/m³ or more, preferably 3.7 Mg/m³ or more, and more preferably 4.0 Mg/m³ or more. On the other hand, when the apparent density exceeds 5.0 Mg/m³, it is difficult to stably control the apparent density from an industrial point of view. Therefore, the apparent density is 5.0 Mg/m³ or less, preferably 4.8 Mg/m³ or less, and more preferably 4.6 Mg/m³ or less.

The apparent density is herein measured by the test method described in JIS Z 2504.

The alloy powder can be used as a stainless steel powder for forming, for example as a stainless steel powder for cladding, 3D printing, or sintering. The stainless steel powder is particularly suitable as an alloy powder for 3D printing.

The steel microstructure of the stainless steel component of the present disclosure and reasons for its limitations will now be described.

The stainless steel component of the present disclosure is formed from the stainless steel powder described above, has the above-described chemical composition, and has a steel microstructure including, by volume fraction, 45% or more of a tempered martensite phase, 0 to 40% of a ferrite phase, and 25% or less of a retained austenite phase.

In order to ensure the intended strength (yield strength), the stainless steel component of the present disclosure has a tempered martensite phase as the main phase. As used herein, the “main phase” refers to a microstructure which accounts for 45% or more, by volume fraction, of the steel component. When the fraction of the tempered martensite phase is less than 45%, the desired strength cannot be achieved. Therefore, the fraction of the tempered martensite phase is 45% or more. The fraction of the tempered martensite phase is preferably 55% or more, more preferably 60% or more, and even more preferably 70% or more. The upper limit of the fraction of the tempered martensite phase may be 100%.

The balance other than the main phase is the ferrite phase, the retained austenite phase, or the ferrite phase and the retained austenite phase.

In order to ensure the intended strength and the intended resistance to sulfide stress corrosion cracking, the volume fraction of the ferrite phase is 40% or less. The fraction of the ferrite phase is preferably 20% or less, more preferably 10% or less, even more preferably 5% or less, and most preferably 3% or less. The stainless steel component of the present disclosure can achieve the above effects even when it consists solely of a tempered martensite phase; therefore, the fraction of the ferrite phase may be 0%.

Since the stainless steel component of the present disclosure can achieve the above effects even when it consists solely of a tempered martensite phase as described above, the fraction of the austenite phase (retained austenite phase) may be 0%. However, the presence of the retained austenite phase can improve the ductility and the low-temperature toughness; therefore, it is preferred to precipitate the austenite phase (retained austenite phase). In particular, in order to achieve the effect of improving ductility and low-temperature toughness, the retained austenite phase is preferably precipitated in an amount exceeding 10% in terms of volume fraction. The volume fraction of the retained austenite is more preferably 13% or more, even more preferably 15% or more. On the other hand, precipitation of a large amount of retained austenite phase, such as an amount exceeding 25% in terms of volume fraction, leads to a reduction in the strength. Therefore, the volume fraction of the retained austenite phase is 25% or less. The volume fraction of retained austenite is preferably 23% or less, more preferably 20% or less.

The above-described steel microstructure of the stainless steel component of the present disclosure can be measured by the following method. First, a test specimen for microstructure observation is taken from a cross-section, extending in a direction perpendicular to the forming direction, of a material (steel component) which has been formed by an additive manufacturing process or the like. The test specimen for microstructure observation is etched by Vilella's reagent (prepared by mixing picric acid, hydrochloric acid, and ethanol in a proportion of 2 g, 10 ml, and 100 ml), and then the microstructure is imaged by a scanning electron microscope (acceleration voltage: 15 kV, magnification: 1000×). The structural fraction (area fraction %) of the ferrite phase is calculated using an image analyzer, and the area fraction is taken as the volume fraction (%) of the ferrite phase.

A test specimen for X-ray diffraction is ground and polished so that a cross-section perpendicular to the forming direction serves as a measurement surface, and the amount of retained austenite (γ) is measured using X-ray diffractometry. The amount of retained austenite is determined by measuring the integrated intensity of diffracted X-rays for the (220) plane of γ and for the (211) plane of α, and converting them to a volume fraction using the following equation:

γ(volume fraction)=100/(1+(IαRγ/IγRα))

where Iα: integrated intensity of α, Rα: crystallographic theoretical calculation value of α, Iγ: integrated intensity of γ, and Rγ: crystallographic theoretical calculation value of γ.

The structural fraction (volume fraction %) of the tempered martensite phase is regarded as the balance other than the ferrite phase and the retained austenite phase.

The steel microstructure of the stainless steel component of the present disclosure can be adjusted within the above ranges of the respective phases by appropriately controlling the below-described heat treatment step (quenching treatment and tempering treatment).

As described above, the stainless steel component of the present disclosure has the particular chemical composition. Further, the steel microstructure is adjusted so that it includes, by volume fraction, 45% or more of a tempered martensite phase, 0 to 40% of a ferrite phase, and 25% or less of a retained austenite phase. The stainless steel component of the present disclosure can therefore achieve the intended strength and properties (corrosion resistance, low-temperature toughness).

The number of inclusions having a major diameter of 2 μm or more is preferably 10/mm² or less for the following reasons. Inclusions having a major diameter of 2 μm or more may serve as the point of origin of pitting corrosion during a sulfide stress corrosion cracking resistance test. Pitting corrosion is accompanied by stress concentration and hydrogen generation, causing sulfide stress cracking. Therefore, in order to improve the resistance to sulfide stress corrosion cracking, it is preferred to reduce the number of inclusions having a major diameter of 2 μm or more. This effect can be achieved when the number of inclusions having a major diameter of 2 μm or more is 10/mm² or less. Therefore, the number of inclusions having a major diameter of 2 μm or more is preferably 10/mm² or less. The number of inclusions having a major diameter of 2 μm or more is more preferably 7/mm² or less, even more preferably 4/mm² or less. The lower limit of the number of inclusions having a major diameter of 2 μm or more is not particularly limited; the number of inclusions having a major diameter of 2 μm or more is desirably 0/mm² or more.

In crystal grains having an orientation difference of 5° or more from adjacent grains, the number of crystal grains having a grain size of 5 μm or more is preferably 10% or less of the total number of crystal grains for the following reasons. Crystal grains having a grain size of 5 μm or more deteriorate the low-temperature toughness and the resistance to sulfide stress corrosion cracking. Therefore, in order to improve the low-temperature toughness and the resistance to sulfide stress corrosion cracking, it is preferred to reduce the size of crystal grains. This effect can be achieved when in crystal grains having an orientation difference of 5° or more from adjacent grains, the number of crystal grains having a grain size of 5 μm or more is 10% or less of the total number of crystal grains. Therefore, in crystal grains having an orientation difference of 5° or more from adjacent grains, the number of crystal grains having a grain size of 5 μm or more is preferably 10% or less, more preferably 9% or less, and even more preferably 8% or less of the total number of crystal grains. In crystal grains having an orientation difference of 5° or more from adjacent grains, the lower limit of the number of crystal grains having a grain size of 5 μm or more is not particularly limited; it is preferably 0% or more.

The stainless steel component of the present disclosure has a yield strength of 655 MPa or more. While the upper limit of the yield strength is not particularly limited, it is preferably 900 MPa or less in order to prevent a reduction in the low-temperature toughness. The stainless steel component of the present disclosure has an absorbed energy vE₋₁₀, determined at a test temperature of −10 °C in a Charpy impact test, of 40 J or more. While the upper limit of the absorbed energy vE₋₁₀ is not particularly limited, it is preferably 300 J or less. Further, the stainless steel component of the present disclosure is also excellent in toughness at a test temperature of −60 °C in a Charpy impact test; the absorbed energy vE₋₆₀ is preferably 40 J or more. On the other hand, the absorbed energy vE₋₆₀ is preferably 200 J or less.

A preferred embodiment of a method for producing the stainless steel powder of the present disclosure will now be described.

The stainless steel powder of the present disclosure is provided in a final material form through a sequence of production steps. For example, the stainless steel powder of the present disclosure is produced through the steps of melting—formation of ingot—remelting of master ingot—production of powder by atomization.

First, in the steps of melting—formation of ingot, predetermined amounts of the above-described elements as materials are melted in a high-frequency vacuum melting furnace, alloyed, and cast to produce an ingot (master ingot). The melting is preferably performed under the conditions of a reduced-pressure Ar atmosphere and a melting temperature of 1600 °C or higher for the following reasons. When the melting temperature is too low, molten steel may solidify when it is dropped from a nozzle, causing clogging of the nozzle. While the upper limit of the melting temperature is not particularly limited, the melting temperature is preferably 1700 °C or lower. From the viewpoint of preventing the oxidation of molten steel, the melting is preferably performed in a reduced-pressure Ar atmosphere. A melting furnace for use in the melting step is not limited to a high-frequency vacuum melting furnace; other melting furnaces (e.g., a Joule heating furnace) can also be used in the present disclosure.

Subsequently, in the steps of remelting of master ingot—atomization, the cast master ingot is remelted in a melting furnace such as a high-frequency or induction furnace, and the melt is subjected to gas atomization using an inert gas such as Ar or He to obtain a powder having a low oxygen content.

Thereafter, the powder is classified to obtain particles having a size of 10 to 200 μm to be used as the stainless steel powder of the present disclosure. The classification may be performed using a sieve or a method such as airflow classification. Water atomization may be used instead of gas atomization.

The apparent density of the powder is controlled by appropriately adjusting the gas pressure, gas flow rate, gas temperature, and converging angle in the gas atomization.

An embodiment of the stainless steel component manufacturing method of the present disclosure will now be described.

The stainless steel component manufacturing method of the present disclosure includes a forming step and a heat treatment step.

First, in the forming step, an additive-manufactured stainless steel object (three-dimensional structure), for example, is formed by an additive manufacturing process (metal powder additive manufacturing process) using the above-described stainless steel powder.

A 3D printing process, for example, can be used as the additive manufacturing process. A laser-type powder bed fusion 3D printer is used here. There is no particular limitation on setting conditions for the 3D printer. From the viewpoint of preventing excessive or insufficient melting, it is preferred to set the laser output to, for example, 150 to 300 W and set the scan speed to, for example, 700 to 1100 mm/s.

Subsequently, in the heat treatment step, the formed three-dimensional structure is subjected to a quenching treatment and a tempering treatment under predetermined conditions to obtain the stainless steel component of the present disclosure. In the heat treatment step, the quenching treatment is preferably performed by heating the structure to a temperature in the range of 850 to 1150 °C, and then cooling the structure to a surface temperature in the range of not more than 50 °C at an average cooling rate equal to or greater than that of air cooling. Thereafter, the tempering treatment is preferably performed by heating the structure to a temperature (tempering temperature) in the range of 500 to 650 °C. The quenching treatment and the tempering treatment are each preferably performed at least once. While there is no particular limitation on the upper limit, the quenching treatment and the tempering treatment are each preferably performed at most three times.

As used herein, the “average cooling rate equal to or greater than that of air cooling” refers to 0.01 °C/s or more. It is to be noted that “average cooling rate equal to or greater than that of water cooling” refers to 0.2 °C/s or more.

### [Quenching Treatment]

From the viewpoint of making the martensite phase finer, the heating temperature (reheating temperature) in the quenching treatment is 850 °C or more, preferably 880 °C or more, and more preferably 900 °C or more. The heating temperature (reheating temperature) in the quenching treatment is 1150 °C or less, preferably 1050 °C or less, and more preferably 1000 °C or less.

From the viewpoint of uniform heating, the three-dimensional structure is preferably held at the above reheating temperature for at least 10 minutes, more preferably for at least 15 minutes. The holding time at the reheating temperature is preferably 60 minutes or less, more preferable 30 minutes or less.

The cooling rate in the quenching treatment is equal to or greater than that of air cooling from the viewpoint of ensuring the desired low-temperature toughness. The average cooling rate in the quenching treatment is preferably 0.01 °C/s or more, more preferably 0.1 °C/s or more. The average cooling rate in the quenching treatment is preferably 200 °C/s or less, more preferably 100 °C/s or less. The average cooling rate herein refers to the average of the cooling rate during the period from the start of cooling to the stoppage of cooling. The cooling stop temperature is a surface temperature of the three-dimensional structure which is set to 50 °C or less, preferably 40 °C or less, and more preferably 30 °C or less. When the cooling stop temperature exceeds 50 °C, retained austenite will precipitate excessively, resulting in a failure to achieve the desired high strength. While the lower limit of the cooling stop temperature is not particularly limited, the cooling stop temperature is preferably 5 °C or more.

### [Tempering Treatment]

When the temperature in the tempering treatment (tempering temperature) exceeds 650 °C, the austenite phase will precipitate excessively, resulting in a failure to achieve the desired high strength. Therefore, the temperature in the tempering treatment (tempering temperature) is 650 °C or less, preferably 630 °C or less. On the other hand, when the tempering temperature is less than 500 °C, the strength will be excessively high, resulting in a failure to achieve the desired low-temperature toughness. Therefore, the tempering temperature is 500 °C or more, preferably 525 °C or more.

From the viewpoint of uniform heating, the three-dimensional structure is preferably held at the above-described tempering temperature for at least 10 minutes, more preferable for at least 20 minutes. The holding time at the tempering temperature is preferably 60 minutes or less, more preferably 40 minutes or less.

The cooling rate in the tempering treatment is preferably equal to or greater than that of air cooling from the viewpoint of ensuring the desired low-temperature toughness. The average cooling rate in the tempering treatment is more preferably 0.01 °C/s or more, even more preferably 0.1 °C/s or more. The average cooling rate in the tempering treatment is preferably 200 °C/s or less, more preferably 100 °C/s or less.

In the stainless steel component manufacturing method of the present disclosure, the three-dimensional structure may be machined into a desired shape before or after the above-described heat treatment step.

As described hereinabove, the stainless steel component of the present disclosure, formed from the stainless steel powder of the present disclosure, has high strength and excellent corrosion resistance and low-temperature toughness, and therefore can advantageously be used as a constituent material (e.g., a sliding member) of a device or equipment, such as a compressor or a pump, for use in a highly corrosive environment as in an oil well. The stainless steel component of the present disclosure can also be used as a coupling or accessory for an oil well. According to the present disclosure, it is possible to reduce the manufacturing cost of special components having various shapes, and to improve their dimensional accuracy.

### EXAMPLES

The following examples illustrate the present disclosure but are not intended to limit the scope of the disclosure.

A method for producing the stainless steel powders (powder alloys) shown in Table 1 will be described in detail. First, each of the chemical compositions, containing the predetermined amounts of components shown in Table 1, was melted in a high-frequency vacuum melting furnace (reduced-pressure Ar atmosphere, melting temperature 1600 °C or more), and cast to produce a master ingot of the alloy. Subsequently, the master ingot of the alloy was remelted in an Ar atmosphere, and powdered by gas atomization to obtain a powder alloy. All the powder alloys obtained were subjected to classification to obtain alloy powders (stainless steel powders) having different particle sizes D₅₀. The particle size D₅₀ and the apparent density of each stainless steel powder were measured by the above-described methods, and the measured values are shown in Table 2.

Next, a three-dimensional structure having a size of 50 mm×80 mm×12 mmt (t: stacking thickness) was manufactured from each powder alloy using a commercially available 3D printer (laser-type powder bed fusion system). The laser output was 250 W, the scan speed was 900 mm/s, and the stacking thickness of one layer was 40 μm. The three-dimensional structure was then subjected to a heat treatment step under the conditions shown in Table 2 to obtain a stainless steel component.

Test specimens were taken from the stainless steel component by the following methods, and the test specimens were subjected to microstructure observation, measurement of the number of inclusions, grain size measurement, a tensile test, a Charpy impact test, and a corrosion resistance test, which were performed by the following methods.

### (1) Microstructure Observation

A test specimen for microstructure observation was taken from the stainless steel component such that a cross-section perpendicular to the forming direction (perpendicular to a stacking surface) served as an observation surface. The test specimen for microstructure observation was etched by Vilella's reagent (prepared by mixing picric acid, hydrochloric acid, and ethanol in a proportion of 2 g, 10 ml, and 100 ml), and then the microstructure was imaged by a scanning electron microscope (acceleration voltage: 15 kV, magnification: 1000×). The structural fraction (area fraction) of the ferrite phase was calculated using an image analyzer, and the fraction was taken as the volume fraction (%) of the ferrite phase.

A test specimen for X-ray diffraction was taken from the stainless steel component, and ground and polished so that a cross-section perpendicular to the forming direction served as a measurement surface. The amount of retained austenite (γ) was measured using X-ray diffractometry. The amount of retained austenite was determined by measuring the integrated intensity of diffracted X-rays for the (220) plane of γ and for the (211) plane of α, and converting them to a volume fraction using the following equation:

γ (volume fraction)=100/(1+(IαRγ/IγRα))

where Iα: integrated intensity of α, Rα: crystallographic theoretical calculation value of α, Iγ: integrated intensity of γ, and Rγ: crystallographic theoretical calculation value of γ.

The structural fraction (volume fraction %) of the tempered martensite phase was determined as the balance other than the ferrite phase and the retained austenite phase.

### (2) Measurement of Number of Inclusions

A 500-mm² region as a scanning electron microscope (SEM) sample was taken, at a ½ position in the thickness direction, from a cross-section perpendicular to the forming direction. Inclusions were identified in the sample by SEM observation, and the number of inclusions per unit area was calculated. Inclusions having a major diameter of 2 μm or more were determined by binarizing the contrast of a reflected electron image of the scanning electron microscope to define the periphery of the inclusion, and measuring the major diameter from the periphery of the inclusion.

### (3) Grain Size Measurement

A sample for grain size measurement was taken, at a ½ position in the thickness direction, from a cross-section perpendicular to the forming direction. Electron backscatter diffraction (EBSD) observation (acceleration voltage: 15 kV, step size: 0.5 μm) was performed on the sample in an area of 300 μm in the width direction and 500 μm in the thickness direction. On the assumption that a grain having an orientation difference of 5° or more constitutes one crystal, the proportion of crystal grains having a grain size of 5 μm or more was measured by the intercept method.

### (4) Tensile Test

A JIS 13B half tensile test specimen (GL=25 mm) was taken from the stainless steel component such that the tensile direction coincides with a direction perpendicular to the forming direction. A tensile test was performed in accordance with the JIS standard (Z 2241:2011) to determine the yield strength YS and the tensile strength TS as tensile properties. A test specimen having a yield strength of 655 MPa or more was evaluated as having high strength and acceptable. On the other hand, a test specimen having a yield strength of less than 655 MPa was evaluated as unacceptable.

### (5) Charpy Impact Test

A V-notch test specimen (10 mm thick) was taken from the stainless steel component such that the longitudinal direction of the test specimen was perpendicular to the forming direction, and a Charpy impact test was performed in accordance with JIS Z 2242 (2018). The test temperature was −10 °C, and the absorbed energy vE₋₁₀ at −10 °C was determined to evaluate the low-temperature toughness. Three test specimens were used for each test, and the arithmetic average of measured values was taken as the absorbed energy (J) of the stainless steel component. Test specimens having an absorbed energy vE₋₁₀ at −10 °C of 40 J or more were evaluated as having high toughness and acceptable. On the other hand, test specimens having an absorbed energy vE₋₁₀ of less than 40 J were evaluated as unacceptable. Further, a test was also performed at a test temperature of −60 °C to determine the absorbed energy vE₋₆₀ at −60 °C. Three test specimens were used for each test, and the arithmetic average of measured values was taken as the absorbed energy (J) of the stainless steel component.

### (6) Corrosion Resistance Test

A corrosion test and a sulfide stress corrosion cracking resistance test (SSCC resistance test) were conducted as corrosion resistance tests.

### [Corrosion Test]

A corrosion test specimen of 3 mm thick×30 mm wide×40 mm long was machined from the stainless steel component, and a corrosion test was performed to evaluate the corrosion resistance to carbon dioxide gas. When the Cr content was 14% or less (condition A), the corrosion test was performed by immersing the corrosion test specimen in a test solution, which was a 20 mass % aqueous NaCl solution held in an autoclave (solution temperature: 150 °C, 10-atm CO₂ gas atmosphere), for 14 days (336 hours). The weight of the test specimen after the corrosion test was measured, and the corrosion rate was calculated from the weight loss before and after the corrosion test. A test specimen was evaluated as acceptable when the corrosion rate was 0.125 mm/y or less, while a test specimen was evaluated as unacceptable when the corrosion rate was more than 0.125 mm/y.

When the Cr content was more than 14% (condition B), the corrosion test was performed by immersing the corrosion test specimen in a test solution, which was a 20 mass % aqueous NaCl solution held in an autoclave (solution temperature: 180 °C, 10-atm CO₂ gas atmosphere), for 14 days (336 hours). The weight of the test specimen after the corrosion test was measured, and the corrosion rate was calculated from the weight loss before and after the corrosion test. A test specimen was evaluated as acceptable when the corrosion rate was 0.125 mm/y or less, while a test specimen was evaluated as unacceptable when the corrosion rate was more than 0.125 mm/y.

Further, the test specimen after the corrosion test was observed for the presence or absence of pitting corrosion on the surface of the test specimen using a magnifying lens at 10-fold magnification. “Pitting corrosion found” refers to the case where pitting corrosion having a diameter of 0.2 mm or more was found. A test specimen having no such pitting corrosion was evaluated as acceptable, and a test specimen having such pitting corrosion was evaluated as unacceptable.

In the examples, a test specimen whose corrosion rate was 0.125 mm/y or less and which had no pitting corrosion was evaluated as excellent in the corrosion resistance to carbon dioxide gas.

### [SSCC Resistance Test]

A round bar-shaped test specimen (diameter: 6.4 mm) was machined from the stainless steel component such that the longitudinal direction of the test specimen was perpendicular to the forming direction, and a SSCC resistance test was performed in accordance with NACE (National Association of Corrosion and Engineering) TM0177 method A. The SSCC resistance test was performed by immersing the test specimen in a test solution, which was a 5 mass % aqueous NaCl solution (solution temperature 25 °C, held in an atmosphere containing 0.1 atm of H₂S and 0.9 atm of CO₂) whose pH had been adjusted to 3.5 by adding acetic acid and Na acetate thereto, for 720 hours, and applying a load stress, which was 100% of the yield stress, to the test specimen. The test specimen after the test was observed for the presence or absence of cracks. A test specimen having no cracks was evaluated as acceptable, while a test specimen having cracks was evaluated as unacceptable.

The results are shown in Table 3.

TABLE 1

| Powder | Components (mass %) | | | | | | | | | | | | | | | | | | | | | | | | | |
|---|---|---|---|---|---|---|---|---|---|---|---|---|---|---|---|---|---|---|---|---|---|---|---|---|---|---|
| No. | C | Si | Mn | P | S | Cr | Ni | V | Al | N | O | Mo | Cu | W | Nb | Ti | B | Zr | Co | Ta | Ca | REM | Mg | Sn | Sb | Remarks |
| A | 0.022 | 0.20 | 0.15 | 0.012 | 0.0012 | 12.0 | 5.57 | 0.021 | 0.034 | 0.0080 | 0.0180 | 2.06 | | | | 0.005 | | | | | 0.0023 | | | | | Suitable steel |
| B | 0.021 | 0.18 | 0.37 | 0.016 | 0.0009 | 12.7 | 5.43 | 0.009 | 0.050 | 0.0521 | 0.0140 | 2.16 | | | | 0.005 | | | | | | | | | | Suitable steel |
| C | 0.012 | 0.18 | 0.35 | 0.017 | 0.0010 | 12.2 | 5.87 | 0.012 | 0.037 | 0.0052 | 0.0170 | 2.14 | | | | 0.010 | | | 0.10 | | 0.0014 | | | | | Suitable steel |
| D | 0.025 | 0.19 | 0.42 | 0.010 | 0.0010 | 12.8 | 5.47 | 0.005 | 0.046 | 0.0538 | 0.0090 | 2.15 | 0.92 | | | 0.002 | | | 0.03 | | | | | | | Suitable steel |
| E | 0.024 | 0.21 | 0.36 | 0.009 | 0.0008 | 12.9 | 5.35 | 0.009 | 0.046 | 0.0545 | 0.0090 | 2.20 | | 0.56 | 0.013 | 0.005 | | — | | | | | | | | Suitable steel |
| F | 0.021 | 0.17 | 0.39 | 0.014 | 0.0010 | 12.9 | 5.38 | 0.005 | 0.045 | 0.0492 | 0.0290 | 2.18 | | | | 0.002 | | | 0.06 | | | | | | | Suitable steel |
| G | 0.029 | 0.20 | 0.42 | 0.010 | 0.0008 | 13.0 | 5.37 | 0.010 | 0.050 | 0.0491 | 0.0090 | 2.16 | | | | 0.001 | | 0.02 | | | | | | 0.068 | | Suitable steel |
| H | 0.020 | 0.23 | 0.37 | 0.018 | 0.0010 | 13.0 | 5.49 | 0.005 | 0.048 | 0.0521 | 0.0200 | 2.22 | | | | 0.003 | | | 0.04 | | | 0.0040 | 0.003 | | | Suitable steel |
| I | 0.014 | 0.18 | 0.38 | 0.018 | 0.0010 | 12.1 | 5.88 | 0.013 | 0.037 | 0.0079 | 0.0080 | 2.12 | | | | 0.013 | | | 0.07 | 0.03 | | | | | 0.068 | Suitable steel |
| J | 0.020 | 0.18 | 0.38 | 0.016 | 0.0010 | 12.8 | 4.40 | 0.008 | 0.020 | 0.0379 | 0.0140 | 0.97 | | | | 0.003 | | | 0.06 | | | | | | | Suitable steel |
| K | 0.014 | 0.24 | 0.41 | 0.015 | 0.0008 | 12.6 | 5.84 | 0.046 | 0.026 | 0.0130 | 0.0250 | 1.94 | | | | 0.012 | | | | | | | | | | Suitable steel |
| L | 0.012 | 0.25 | 0.40 | 0.017 | 0.0010 | 12.1 | 5.48 | 0.049 | 0.044 | 0.0068 | 0.0250 | 1.93 | | | | 0.009 | | | 0.23 | | | | | | | Suitable steel |
| O | 0.025 | 0.16 | 0.40 | 0.017 | 0.0008 | 10.7 | 5.37 | 0.008 | 0.053 | 0.0579 | 0.0110 | 2.17 | | | | | | | | | | | | | | Comp. steel |
| P | 0.013 | 0.14 | 0.34 | 0.021 | 0.0010 | 12.2 | 6.70 | 0.010 | 0.032 | 0.0053 | 0.0370 | 2.15 | | | | 0.007 | | | 0.09 | | | | | | | Suitable steel |
| Q | 0.019 | 0.22 | 0.36 | 0.012 | 0.0010 | 12.8 | 0.30 | 0.013 | 0.017 | 0.0380 | 0.0130 | 0.98 | | | | | | | 0.06 | | | | | | | Comp. steel |
| R | 0.008 | 0.14 | 0.32 | 0.015 | 0.0010 | 12.2 | 5.91 | 0.010 | 0.039 | 0.0075 | 0.0230 | 3.16 | | | | 0.010 | | | 0.08 | | | | | | | Suitable steel |
| S | 0.021 | 0.20 | 0.37 | 0.018 | 0.0010 | 12.9 | 4.31 | 0.009 | 0.018 | 0.0339 | 0.0200 | 0.40 | | | | | | | 0.10 | | | | | | | Suitable steel |
| T | 0.014 | 0.22 | 0.42 | 0.020 | 0.0010 | 12.5 | 5.83 | 0.043 | 0.024 | 0.0382 | 0.0360 | 1.90 | | | | 0.019 | | | 0.04 | | | | | | | Suitable steel |
| U | 0.017 | 0.17 | 0.20 | 0.013 | 0.0010 | 12.2 | 5.64 | 0.025 | 0.031 | 0.0145 | 0.0190 | 2.00 | | | | | | | 0.38 | | | | | | | Suitable steel |
| AA | 0.018 | 0.29 | 0.44 | 0.024 | 0.0011 | 14.9 | 5.40 | 0.033 | 0.012 | 0.0860 | 0.0120 | 1.80 | | | | | | | 0.14 | | | | | | | Suitable steel |
| AC | 0.028 | 0.17 | 0.34 | 0.022 | 0.0012 | 14.2 | 6.00 | 0.041 | 0.009 | 0.0720 | 0.0190 | 1.70 | 0.68 | | 0.060 | | | | 0.05 | | | | | | | Suitable steel |
| AF | 0.023 | 0.19 | 0.37 | 0.022 | 0.0011 | 14.7 | 6.00 | 0.037 | 0.009 | 0.0530 | 0.0170 | 2.00 | | | 0.062 | | | | 0.07 | | | | | | | Suitable steel |
| AG | 0.019 | 0.20 | 0.38 | 0.021 | 0.0011 | 14.6 | 6.30 | 0.043 | 0.009 | 0.0690 | 0.0190 | 1.90 | | | 0.060 | | | | 0.05 | | 0.0018 | 0.0035 | | | | Suitable steel |
| AH | 0.028 | 0.19 | 0.32 | 0.022 | 0.0009 | 14.6 | 6.10 | 0.042 | 0.009 | 0.0460 | 0.0210 | 2.10 | 0.60 | | 0.099 | | | | 0.05 | | 0.0022 | 0.0037 | | | | Suitable steel |
| AV | 0.020 | 0.32 | 0.47 | 0.026 | 0.0009 | 15.0 | 5.60 | 0.029 | 0.012 | 0.0840 | 0.0100 | 1.80 | | | | | | 0.05 | 0.16 | | | | | | | Suitable steel |
| BA | 0.065 | 0.20 | 0.33 | 0.016 | 0.0009 | 13.3 | 5.36 | 0.022 | 0.033 | 0.0380 | 0.0220 | 1.98 | 0.63 | 0.54 | 0.061 | | | | | | | | | | | Comp. steel |
| BB | 0.015 | 0.18 | 0.33 | 0.021 | 0.0013 | 13.3 | 5.35 | 0.027 | 0.032 | 0.0460 | 0.0150 | 3.60 | 0.81 | 0.65 | 0.060 | | | | | | | | | | | Comp. steel |
| BC | 0.020 | 0.22 | 0.42 | 0.014 | 0.0013 | 13.2 | 5.38 | 0.021 | 0.034 | 0.0430 | 0.0200 | 3.39 | 0.67 | 0.59 | 0.059 | | | | | | | | | | | Suitable steel |
| BD | 0.016 | 0.22 | 0.39 | 0.021 | 0.0013 | 13.2 | 5.43 | 0.021 | 0.026 | 0.0420 | 0.0160 | 1.90 | 3.38 | 0.49 | 0.059 | | | | | | | | | | | Suitable steel |
| BE | 0.021 | 0.19 | 0.34 | 0.019 | 0.0011 | 13.3 | 5.37 | 0.017 | 0.032 | 0.0380 | 0.0160 | 1.84 | 3.64 | 0.61 | 0.055 | | | | | | | | | | | Comp. steel |
| BF | 0.024 | 0.18 | 0.32 | 0.020 | 0.0014 | 13.2 | 7.87 | 0.020 | 0.026 | 0.0430 | 0.0150 | 1.96 | 0.71 | 0.65 | 0.064 | | | | | | | | | | | Suitable steel |
| BG | 0.014 | 0.22 | 0.36 | 0.015 | 0.0010 | 13.0 | 5.47 | 0.022 | 0.026 | 0.0370 | 0.0210 | 1.88 | 0.82 | 2.76 | 0.062 | | | | | | | | | | | Suitable steel |
| BH | 0.022 | 0.22 | 0.37 | 0.012 | 0.0012 | 13.3 | 5.31 | 0.022 | 0.026 | 0.0430 | 0.0160 | 2.00 | 0.63 | 0.55 | 0.055 | | 0.0030 | | | | | | | | | Suitable steel |
| BI | 0.020 | 0.20 | 0.38 | 0.022 | 0.0009 | 13.2 | 5.42 | 0.017 | 0.031 | 0.0370 | 0.0130 | 1.93 | 0.82 | 0.46 | 0.054 | 0.099 | | | | | | | | | | Suitable steel |
| BJ | 0.024 | 0.19 | 0.33 | 0.019 | 0.0011 | 13.2 | 2.36 | 0.024 | 0.029 | 0.0380 | 0.0140 | 1.92 | 0.69 | 0.60 | 0.063 | | | | | | | | | | | Comp. steel |
| BK | 0.026 | 0.23 | 0.40 | 0.010 | 0.0007 | 13.1 | 5.33 | 0.010 | 0.043 | 0.0569 | 0.0105 | 2.16 | | 0.61 | 0.413 | 0.007 | | | | | | | | | | Suitable steel |
| BL | 0.025 | 0.20 | 0.41 | 0.008 | 0.0007 | 12.8 | 5.35 | 0.006 | 0.042 | 0.0503 | 0.0089 | 2.20 | | 0.55 | 0.014 | | | | | | 0.0046 | | | | | Suitable steel |
| BM | 0.027 | 0.19 | 0.41 | 0.008 | 0.0009 | 13.0 | 5.33 | 0.009 | 0.043 | 0.0557 | 0.0068 | 2.17 | | 0.55 | 0.010 | 0.005 | | | | | | 0.0080 | | | | Suitable steel |
| BN | 0.020 | 0.19 | 0.41 | 0.007 | 0.0007 | 13.0 | 5.39 | 0.011 | 0.048 | 0.0520 | 0.0101 | 2.15 | | 0.55 | 0.009 | 0.002 | | | | | | | 0.007 | | | Suitable steel |
| BC | 0.024 | 0.23 | 0.41 | 0.007 | 0.0008 | 13.1 | 5.32 | 0.012 | 0.044 | 0.0561 | 0.0089 | 2.25 | | 0.60 | 0.010 | 0.009 | | | | | | | | 0.190 | | Suitable steel |
| BP | 0.027 | 0.24 | 0.38 | 0.010 | 0.0008 | 12.9 | 5.33 | 0.014 | 0.048 | 0.0499 | 0.0105 | 2.22 | | 0.55 | 0.010 | 0.006 | | | | | | | | | 0.136 | Suitable steel |
| BQ | 0.021 | 0.19 | 0.33 | 0.013 | 0.0010 | 12.5 | 5.54 | 0.011 | 0.043 | 0.0347 | 0.0134 | 2.140 | 0.92 | 0.56 | 0.013 | 0.005 | | | | | | | | | | Suitable steel |
| BR | 0.023 | 0.22 | 0.17 | 0.010 | 0.0013 | 11.9 | 5.55 | 0.022 | 0.034 | 0.0070 | 0.0200 | 2.07 | | | | | | | | | | | | | | Suitable steel |

Blanks: not intentionally added

TABLE 2

| | Powder used | | | Heat treatment | | | | | | | Heat treatment (second) | | | | | | |
|---|---|---|---|---|---|---|---|---|---|---|---|---|---|---|---|---|---|
| | | Powder | | Quenching | | | | Tempering | | | Quenching | | | | Tempering | | |
| | | particle | Apparent | Heating | Soaking | | Cooling | Tempering | Soaking | | Heating | Soaking | | Cooling | Tempering | Soaking | |
| Component | Powder | size D₅₀ | density | temp. | time | | stop temp. | temp. | time | | temp. | time | | stop temp. | temp. | time | |
| No. | No. | (μm) | (Mg/m³) | (°C) | (min) | Cooling | (°C) | (°C) | (min) | Cooling | (°C) | (min) | Cooling | (°C) | (°C) | (min) | Cooling |
| 1 | A | 55 | 4.2 | 912 | 11 | Air cooling | 16 | 609 | 20 | Air cooling | | | | | | | |
| 2 | B | 67 | 4.4 | 920 | 17 | Air cooling | 28 | 596 | 29 | Air cooling | | | | | | | |
| 3 | C | 32 | 3.5 | 914 | 19 | Air cooling | 25 | 631 | 23 | Air cooling | | | | | | | |
| 4 | D | 45 | 4.0 | 914 | 13 | Air cooling | 16 | 615 | 40 | Air cooling | | | | | | | |
| 5 | E | 32 | 3.9 | 913 | 27 | Air cooling | 15 | 607 | 55 | Air cooling | | | | | | | |
| 6 | F | 40 | 4.3 | 934 | 13 | Air cooling | 28 | 625 | 48 | Air cooling | | | | | | | |
| 7 | G | 42 | 4.0 | 934 | 30 | Air cooling | 30 | 605 | 27 | Air cooling | | | | | | | |
| 8 | H | 50 | 4.4 | 933 | 26 | Air cooling | 16 | 605 | 56 | Air cooling | | | | | | | |
| 9 | I | 59 | 3.7 | 907 | 19 | Air cooling | 30 | 602 | 26 | Air cooling | | | | | | | |
| 10 | J | 40 | 4.3 | 922 | 14 | Air cooling | 24 | 625 | 24 | Air cooling | | | | | | | |
| 11 | K | 34 | 3.7 | 914 | 19 | Air cooling | 17 | 582 | 46 | Air cooling | | | | | | | |
| 12 | L | 32 | 3.9 | 918 | 13 | Air cooling | 26 | 584 | 51 | Air cooling | | | | | | | |
| 13 | O | 56 | 3.8 | 915 | 15 | Air cooling | 26 | 616 | 37 | Air cooling | | | | | | | |
| 14 | P | 50 | 4.1 | 932 | 26 | Air cooling | 28 | 614 | 28 | Air cooling | | | | | | | |
| 15 | Q | 38 | 3.7 | 936 | 17 | Air cooling | 24 | 614 | 28 | Air cooling | | | | | | | |
| 16 | R | 59 | 3.7 | 913 | 18 | Air cooling | 28 | 608 | 28 | Air cooling | | | | | | | |
| 17 | S | 80 | 3.9 | 904 | 28 | Air cooling | 23 | 615 | 53 | Air cooling | | | | | | | |
| 18 | T | 45 | 4.5 | 933 | 15 | Air cooling | 25 | 620 | 22 | Air cooling | | | | | | | |
| 19 | U | 19 | 4.0 | 925 | 29 | Air cooling | 19 | 615 | 57 | Air cooling | | | | | | | |
| 20 | AA | 39 | 3.9 | 890 | 20 | Air cooling | 30 | 540 | 20 | Air cooling | | | | | | | |
| 21 | AA | 40 | 3.5 | 890 | 20 | Air cooling | 30 | 535 | 20 | Air cooling | 890 | 20 | Air cooling | 30 | 545 | 20 | Air cooling |
| 22 | AC | 47 | 3.9 | 890 | 20 | Air cooling | 30 | 535 | 20 | Air cooling | | | | | | | |
| 23 | AF | 83 | 4.4 | 890 | 20 | Air cooling | 30 | 545 | 20 | Air cooling | | | | | | | |
| 24 | AF | 44 | 4.6 | 1060 | 20 | Air cooling | 30 | 540 | 20 | Air cooling | | | | | | | |
| 25 | AG | 38 | 4.4 | 890 | 20 | Air cooling | 30 | 535 | 20 | Air cooling | | | | | | | |
| 26 | AH | 25 | 3.8 | 890 | 20 | Air cooling | 30 | 545 | 20 | Air cooling | | | | | | | |
| 27 | AV | 25 | 3.6 | 890 | 20 | Air cooling | 90 | 545 | 11 | Air cooling | | | | | | | |
| 28 | AA | 26 | 3.7 | 890 | 20 | Air cooling | 15 | 535 | 20 | Air cooling | | | | | | | |
| 29 | A | 6 | 4.1 | 912 | 11 | Air cooling | 16 | 609 | 20 | Air cooling | | | | | | | |
| 30 | A | 218 | 4.1 | 912 | 11 | Air cooling | 16 | 609 | 20 | Air cooling | | | | | | | |
| 31 | BA | 65 | 4.5 | 917 | 19 | Air cooling | 26 | 589 | 30 | Air cooling | | | | | | | |
| 32 | BB | 38 | 3.8 | 917 | 19 | Air cooling | 26 | 589 | 30 | Air cooling | | | | | | | |
| 33 | BC | 32 | 3.9 | 917 | 19 | Air cooling | 26 | 589 | 30 | Air cooling | | | | | | | |
| 34 | BD | 74 | 4.5 | 917 | 19 | Air cooling | 26 | 589 | 30 | Air cooling | | | | | | | |
| 35 | BE | 31 | 4.3 | 917 | 19 | Air cooling | 26 | 589 | 30 | Air cooling | | | | | | | |
| 36 | BF | 21 | 4.4 | 917 | 19 | Air cooling | 26 | 589 | 30 | Air cooling | | | | | | | |
| 37 | BG | 41 | 4.3 | 917 | 19 | Air cooling | 26 | 589 | 30 | Air cooling | | | | | | | |
| 38 | BH | 48 | 3.7 | 917 | 19 | Air cooling | 26 | 589 | 30 | Air cooling | | | | | | | |
| 39 | BI | 49 | 4.5 | 917 | 19 | Air cooling | 26 | 589 | 30 | Air cooling | | | | | | | |
| 40 | BJ | 48 | 4.5 | 917 | 19 | Air cooling | 26 | 589 | 30 | Air cooling | | | | | | | |
| 41 | BK | 31 | 4.3 | 913 | 27 | Air cooling | 15 | 622 | 55 | Air cooling | | | | | | | |
| 42 | BL | 34 | 3.6 | 913 | 27 | Air cooling | 15 | 607 | 55 | Air cooling | | | | | | | |
| 43 | BM | 39 | 4.1 | 913 | 27 | Air cooling | 15 | 607 | 55 | Air cooling | | | | | | | |
| 44 | BN | 33 | 3.8 | 913 | 27 | Air cooling | 15 | 607 | 55 | Air cooling | | | | | | | |
| 45 | BO | 26 | 4.2 | 913 | 27 | Air cooling | 15 | 607 | 55 | Air cooling | | | | | | | |
| 46 | BP | 27 | 4.2 | 913 | 27 | Air cooling | 15 | 607 | 55 | Air cooling | | | | | | | |
| 47 | BQ | 45 | 3.0 | 918 | 17 | Air cooling | 21 | 614 | 36 | Air cooling | | | | | | | |
| 48 | BR | 60 | 4.1 | 912 | 11 | Air cooling | 16 | 609 | 20 | Air cooling | | | | | | | |
| 49 | A | 55 | 4.2 | 912 | 11 | Air cooling | 16 | 630 | 20 | Air cooling | | | | | | | |
| 50 | C | 32 | 3.5 | 914 | 19 | Air cooling | 25 | 655 | 23 | Air cooling | | | | | | | |
| 51 | I | 59 | 3.7 | 907 | 19 | Air cooling | 30 | 620 | 26 | Air cooling | | | | | | | |
| 52 | J | 40 | 4.3 | 922 | 14 | Air cooling | 24 | 647 | 24 | Air cooling | | | | | | | |
| 53 | K | 34 | 3.7 | 914 | 19 | Air cooling | 17 | 601 | 46 | Air cooling | | | | | | | |
| 54 | L | 32 | 3.9 | 918 | 13 | Air cooling | 26 | 601 | 51 | Air cooling | | | | | | | |
| 55 | R | 59 | 3.7 | 913 | 18 | Air cooling | 28 | 625 | 28 | Air cooling | | | | | | | |
| 56 | T | 45 | 4.5 | 933 | 15 | Air cooling | 25 | 638 | 22 | Air cooling | | | | | | | |
| 57 | BN | 33 | 3.8 | 913 | 27 | Air cooling | 15 | 626 | 55 | Air cooling | | | | | | | |
| 58 | BR | 60 | 4.1 | 912 | 11 | Air cooling | 16 | 631 | 20 | Air cooling | | | | | | | |

Blanks: treatment not performed

TABLE 3

| | | Steel microstructure | | | | | | | | | | | | Sulfide stress | |
|---|---|---|---|---|---|---|---|---|---|---|---|---|---|---|---|
| | | Volume | | Volume | Proportion of | Number of | | | | | | | | corrosion | |
| | | fraction | Volume | fraction | crystal grains | inclusions | Tensile properties | | | | | | | cracking | |
| | | of tempered | fraction | of retained | having a grain | having a major | Yield | Tensile | | | CO₂ | Corrosion properties | | resistance | |
| | | martensite | of ferrite | austenite | size of 5 | diameter of 2 | strength | strength | Low-temperature toughness | | corrosion | Corrosion | | Sulfide stress | |
| Component | Powder | phase | phase | phase | μm or more | μm or more | YS | TS | -vE₋₁₀ | -vE₋₆₀ | test | rate | Pitting | corrosion | |
| No. | No. | (%) | (%) | (%) | (%) | (/mm²) | (MPa) | (MPa) | (J) | (J) | condition | (mm/y) | corrosion | cracking | Remarks |
| 1 | A | 89 | 0 | 11 | 4.6 | 3.2 | 853 | 1013 | 226 | 167 | A | 0.034 | none | none | Inventive Ex. |
| 2 | B | 86 | 0 | 14 | 5.1 | 2.8 | 881 | 1093 | 199 | 161 | A | 0.019 | none | none | Inventive Ex. |
| 3 | C | 94 | 0 | 6 | 6.3 | 2.9 | 808 | 906 | 212 | 172 | A | 0.021 | none | none | Inventive Ex. |
| 4 | D | 85 | 0 | 15 | 5.6 | 2.7 | 898 | 1101 | 197 | 178 | A | 0.017 | none | none | Inventive Ex. |
| 5 | E | 88 | 1 | 11 | 4.2 | 3.0 | 868 | 1113 | 188 | 162 | A | 0.019 | none | none | Inventive Ex. |
| 6 | F | 87 | 0 | 13 | 4.6 | 2.5 | 862 | 1083 | 184 | 171 | A | 0.017 | none | none | Inventive Ex. |
| 7 | G | 81 | 0 | 19 | 3.7 | 1.5 | 871 | 1134 | 191 | 171 | A | 0.020 | none | none | Inventive Ex. |
| 8 | H | 85 | 0 | 15 | 6.3 | 1.9 | 873 | 1090 | 196 | 170 | A | 0.016 | none | none | Inventive Ex. |
| 9 | I | 92 | 1 | 7 | 4.7 | 2.2 | 830 | 922 | 165 | 117 | A | 0.026 | none | none | Inventive Ex. |
| 10 | J | 89 | 1 | 10 | 3.9 | 2.1 | 855 | 1014 | 204 | 179 | A | 0.060 | none | none | Inventive Ex. |
| 11 | K | 96 | 1 | 3 | 3.2 | 2.5 | 833 | 917 | 197 | 164 | A | 0.023 | none | none | Inventive Ex. |
| 12 | L | 97 | 0 | 3 | 6.9 | 2.7 | 833 | 919 | 215 | 173 | A | 0.036 | none | none | Inventive Ex. |
| 13 | O | 86 | 0 | 14 | 6.2 | 2.9 | 872 | 1093 | 198 | 175 | A | 0.129 | none | none | Comp. Ex. |
| 14 | P | 73 | 0 | 24 | 4.2 | 1.9 | 753 | 972 | 207 | 165 | A | 0.014 | none | none | Inventive Ex. |
| 15 | Q | 95 | 0 | 5 | 6.2 | 2.2 | 762 | 894 | 8 | 11 | A | 0.830 | found | found | Comp. Ex. |
| 16 | R | 93 | 0 | 7 | 8.5 | 1.9 | 811 | 889 | 193 | 158 | A | 0.013 | none | none | Inventive Ex. |
| 17 | S | 92 | 0 | 8 | 6.6 | 2.6 | 858 | 1002 | 204 | 178 | A | 0.078 | none | none | Inventive Ex. |
| 18 | T | 89 | 1 | 10 | 3.3 | 3.6 | 816 | 925 | 196 | 176 | A | 0.023 | none | none | Inventive Ex. |
| 19 | U | 91 | 0 | 9 | 4.6 | 2.3 | 869 | 1007 | 191 | 166 | A | 0.035 | none | none | Inventive Ex. |
| 20 | AA | 100 | 0 | 0 | 6.0 | 2.6 | 981 | 1211 | 208 | 176 | B | 0.063 | none | none | Inventive Ex. |
| 21 | AA | 99 | 0 | 1 | 4.9 | 3.0 | 965 | 1216 | 192 | 175 | B | 0.067 | none | none | Inventive Ex. |
| 22 | AC | 100 | 0 | 0 | 6.5 | 2.4 | 934 | 1169 | 196 | 178 | B | 0.078 | none | none | Inventive Ex. |
| 23 | AF | 99 | 0 | 1 | 6.0 | 2.6 | 927 | 1158 | 126 | 19 | B | 0.071 | none | none | Inventive Ex. |
| 24 | AF | 98 | 1 | 1 | 5.2 | 2.3 | 939 | 1178 | 125 | 20 | B | 0.060 | none | none | Inventive Ex. |
| 25 | AG | 100 | 0 | 0 | 4.6 | 2.5 | 890 | 1117 | 190 | 162 | B | 0.065 | none | none | Inventive Ex. |
| 26 | AH | 100 | 0 | 0 | 7.6 | 2.8 | 861 | 1082 | 210 | 170 | B | 0.055 | none | none | Inventive Ex. |
| 27 | AV | 68 | 2 | 30 | 5.3 | 3.1 | 636 | 976 | 178 | 156 | B | 0.060 | none | none | Comp. Ex. |
| 28 | AA | 100 | 0 | 0 | 6.5 | 3.1 | 1067 | 1209 | 193 | 166 | B | 0.062 | none | none | Inventive Ex. |
| 29 | A | 88 | 0 | 12 | 8.2 | 2.7 | 879 | 983 | 24 | 7 | A | 0.031 | found | found | Comp. Ex. |
| 30 | A | 88 | 0 | 12 | 4.1 | 1.9 | 879 | 1023 | 35 | 13 | A | 0.032 | found | found | Comp. Ex. |
| 31 | BA | 85 | 0 | 15 | 5.0 | 2.6 | 715 | 929 | 188 | 155 | A | 0.021 | none | found | Comp. Ex. |
| 32 | BB | 78 | 14 | 8 | 4.8 | 3.2 | 709 | 873 | 191 | 166 | A | 0.003 | none | found | Comp. Ex. |
| 33 | BC | 80 | 11 | 9 | 4.9 | 2.5 | 738 | 924 | 214 | 165 | A | 0.005 | none | none | Inventive Ex. |
| 34 | BD | 92 | 0 | 8 | 2.8 | 2.8 | 718 | 890 | 198 | 174 | A | 0.003 | none | none | Inventive Ex. |
| 35 | BE | 92 | 0 | 8 | 7.2 | 2.8 | 758 | 939 | 202 | 172 | A | 0.002 | none | found | Comp. Ex. |
| 36 | BF | 70 | 0 | 25 | 5.5 | 2.5 | 674 | 1254 | 201 | 177 | A | 0.003 | none | none | Inventive Ex. |
| 37 | BG | 85 | 8 | 7 | 5.9 | 2.4 | 745 | 911 | 187 | 169 | A | 0.006 | none | none | Inventive Ex. |
| 38 | BH | 90 | 2 | 8 | 4.0 | 1.5 | 724 | 897 | 191 | 174 | A | 0.010 | none | none | Inventive Ex. |
| 39 | BI | 90 | 1 | 9 | 4.6 | 2.6 | 703 | 876 | 69 | 7 | A | 0.009 | none | none | Inventive Ex. |
| 40 | BJ | 74 | 19 | 7 | 5.3 | 2.8 | 720 | 885 | 36 | 11 | A | 0.061 | none | none | Comp. Ex. |
| 41 | BK | 86 | 0 | 14 | 3.5 | 2.9 | 928 | 1043 | 45 | 11 | A | 0.020 | none | none | Inventive Ex. |
| 42 | BL | 87 | 1 | 12 | 3.3 | 3.1 | 878 | 1126 | 169 | 135 | A | 0.018 | none | none | Inventive Ex. |
| 43 | BM | 86 | 1 | 13 | 4.4 | 2.4 | 881 | 1130 | 179 | 154 | A | 0.021 | none | none | Inventive Ex. |
| 44 | BN | 89 | 1 | 10 | 3.4 | 3.5 | 855 | 1096 | 176 | 154 | A | 0.021 | none | none | Inventive Ex. |
| 45 | BO | 87 | 0 | 13 | 3.6 | 2.1 | 864 | 1108 | 202 | 179 | A | 0.014 | none | none | Inventive Ex. |
| 46 | BP | 83 | 2 | 15 | 4.9 | 3.6 | 861 | 1104 | 208 | 164 | A | 0.020 | none | none | Inventive Ex. |
| 47 | BQ | 88 | 0 | 12 | 5.1 | 2.9 | 862 | 1051 | 21 | 10 | A | 0.021 | found | found | Comp. Ex. |
| 48 | BR | 86 | 2 | 12 | 5.0 | 2.9 | 855 | 1010 | 223 | 165 | A | 0.037 | none | none | Inventive Ex. |
| 49 | A | 90 | 0 | 10 | 5.0 | 3.1 | 756 | 956 | 223 | 158 | A | 0.029 | none | none | Inventive Ex. |
| 50 | C | 92 | 0 | 8 | 6.4 | 3.4 | 717 | 849 | 222 | 154 | A | 0.020 | none | none | Inventive Ex. |
| 51 | I | 92 | 0 | 8 | 5.0 | 1.8 | 740 | 857 | 160 | 133 | A | 0.030 | none | none | Inventive Ex. |
| 52 | J | 89 | 1 | 10 | 3.5 | 2.6 | 749 | 959 | 188 | 193 | A | 0.060 | none | none | Inventive Ex. |
| 53 | K | 97 | 2 | 1 | 3.3 | 2.3 | 738 | 863 | 181 | 172 | A | 0.020 | none | none | Inventive Ex. |
| 54 | L | 99 | 0 | 1 | 7.4 | 3.1 | 730 | 852 | 216 | 193 | A | 0.036 | none | none | Inventive Ex. |
| 55 | R | 91 | 0 | 9 | 8.7 | 2.3 | 708 | 819 | 174 | 172 | A | 0.016 | none | none | Inventive Ex. |
| 56 | T | 88 | 1 | 11 | 3.2 | 3.6 | 723 | 859 | 200 | 160 | A | 0.021 | none | none | Inventive Ex. |
| 57 | BN | 88 | 1 | 11 | 3.2 | 3.4 | 750 | 1040 | 180 | 141 | A | 0.020 | none | none | Inventive Ex. |
| 58 | BR | 84 | 3 | 13 | 5.2 | 3.3 | 747 | 956 | 240 | 170 | A | 0.032 | none | none | Inventive Ex. |

For all of the stainless steel powders of the disclosed examples, the chemical composition, the particle size D₅₀, and the apparent density were controlled within appropriate ranges. The stainless steel components formed from the steel powders had a high strength, an excellent low-temperature toughness in the low-temperature environment, and an excellent corrosion resistance in the high-temperature severe corrosive environment containing CO₂ and Cl⁻ and in the environment containing H₂S.

On the other hand, in the comparative examples lying outside the scope of the present disclosure, the comparative stainless steel powders were each not controlled within an appropriate range. The comparative stainless steel components formed from the steel powders did not achieve a property value as intended for the presently disclosed embodiments in at least one of the yield strength, the corrosion resistance, and the low-temperature toughness.

1-9. (canceled)

10. A stainless steel powder having a chemical composition comprising, in % by mass:
C: 0.001 to 0.06%;
Si: 0.01 to 1.0%;
Mn: 0.01 to 2.0%;
P: 0.05% or less;
S: less than 0.005%;
Cr: more than 11.0% and not more than 15.0%;
Ni: 2.5 to 8.0%;
V: 0.005 to 0.5%;
Al: 0.1% or less;
N: 0.100% or less;
O: 0.3% or less; and
Mo: 3.5% or less,
with the balance being Fe and incidental impurities,
wherein the stainless steel powder has a particle size D₅₀, which is a median diameter at a 50% position in a mass cumulative distribution, of 10 to 200 μm, and an apparent density of 3.5 to 5.0 Mg/m³.

11. The stainless steel powder according to claim 10, wherein the chemical composition further comprises, in % by mass, at least one selected from the following:
Cu: 3.5% or less;
W: 3.0% or less;
Nb: 0.5% or less;
Ti: 0 to 0.30%;
B: 0 to 0.0050%;
Zr: 0 to 0.2%;
Co: 0 to 1.0%;
Ta: 0 to 0.1%;
Ca: 0 to 0.050%;
rare-earth metals (REM): 0 to 0.1%;
Mg: 0 to 0.01%;
Sn: 0 to 0.5%; and
Sb: 0 to 0.5%.

12. A stainless steel component having a chemical composition comprising, in % by mass:
C: 0.001 to 0.06%;
Si: 0.01 to 1.0%;
Mn: 0.01 to 2.0%;
P: 0.05% or less;
S: less than 0.005%;
Cr: more than 11.0% and not more than 15.0%;
Ni: 2.5 to 8.0%;
V: 0.005 to 0.5%;
Al: 0.1% or less;
N: 0.100% or less;
O: 0.3% or less; and
Mo: 3.5% or less,
with the balance being Fe and incidental impurities,
wherein the stainless steel component has a steel microstructure comprising, by volume fraction, 45% or more of a tempered martensite phase, 0 to 40% of a ferrite phase, and 25% or less of a retained austenite phase, has a yield strength of 655 MPa or more, and has an absorbed energy vE₋₁₀, determined at a test temperature of −10 °C in a Charpy impact test, of 40 J or more.

13. The stainless steel component according to claim 12, wherein the chemical composition further comprises, in % by mass, at least one selected from the following:
Cu: 3.5% or less;
W: 3.0% or less;
Nb: 0.5% or less;
Ti: 0 to 0.30%;
B: 0 to 0.0050%;
Zr: 0 to 0.2%;
Co: 0 to 1.0%;
Ta: 0 to 0.1%;
Ca: 0 to 0.050%;
rare-earth metals (REM): 0 to 0.1%;
Mg: 0 to 0.01%;
Sn: 0 to 0.5%; and
Sb: 0 to 0.5%.

14. The stainless steel component according to claim 12, wherein the number of inclusions having a major diameter of 2 μm or more is 10/mm² or less.

15. The stainless steel component according to claim 13, wherein the number of inclusions having a major diameter of 2 μm or more is 10/mm² or less.

16. The stainless steel component according to claim 12, wherein in the tempered martensite phase, among crystal grains having an orientation difference of 5° or more from adjacent grains, the number of crystal grains having a grain size of 5 μm or more is 10% or less of the total number of crystal grains.

17. The stainless steel component according to claim 13, wherein in the tempered martensite phase, among crystal grains having an orientation difference of 5° or more from adjacent grains, the number of crystal grains having a grain size of 5 μm or more is 10% or less of the total number of crystal grains.

18. The stainless steel component according to claim 14, wherein in the tempered martensite phase, among crystal grains having an orientation difference of 5° or more from adjacent grains, the number of crystal grains having a grain size of 5 μm or more is 10% or less of the total number of crystal grains.

19. The stainless steel component according to claim 15, wherein in the tempered martensite phase, among crystal grains having an orientation difference of 5° or more from adjacent grains, the number of crystal grains having a grain size of 5 μm or more is 10% or less of the total number of crystal grains.

20. A method for manufacturing a stainless steel component, comprising:
a forming step of forming an object using the stainless steel powder according to claim 10; and
a heat treatment step including at least one quenching treatment which involves heating the object to a temperature in the range of 850 to 1150 °C, and then cooling the object to a temperature in the range of not more than 50 °C at an average cooling rate equal to or greater than that of air cooling, and at least one tempering treatment which involves heating the object to a temperature in the range of 500 to 650 °C.

21. A method for manufacturing a stainless steel component, comprising:
a forming step of forming an object using the stainless steel powder according to claim 11; and
a heat treatment step including at least one quenching treatment which involves heating the object to a temperature in the range of 850 to 1150 °C, and then cooling the object to a temperature in the range of not more than 50 °C at an average cooling rate equal to or greater than that of air cooling, and at least one tempering treatment which involves heating the object to a temperature in the range of 500 to 650 °C.

22. The method for manufacturing a stainless steel component according to claim 20, wherein the forming step is a step of forming the object using an additive manufacturing process.

23. The method for manufacturing a stainless steel component according to claim 21, wherein the forming step is a step of forming the object using an additive manufacturing process.
